(19) United States
(12) Patent Application Publication
(10) Pub. No.: US 2008/0096987 A1
(43) Pub. Date: Apr. 24, 2008

(54) Method for the Production of Monodispersed Ion Exchangers Containing Pores

(76) Inventors: Wolfgang Podszun, Munchen (DE); Pierre Vanhoorne, Monheim (DE)

Correspondence Address: LANXESS CORPORATION, 111 RIDC PARK WEST DRIVE, PITTSBURGH, PA, 15275-1112, US

(21) Appl. No.: 10/588,330

(22) PCT Filed: Aug. 18, 2005
(86) PCT No.: PCT/EP05/00671

§ 371 Date: Apr. 10, 2007

(30) Foreign Application Priority Data
Feb. 6, 2004 (EP) 10 2004 006 11.5

(51) Int. Cl. B01J 41/00; C08F 2/00

(52) U.S. Cl. 521/25

(57) ABSTRACT

The present invention relates to a method for the production of monodisperse pore-containing ion exchangers, and also of monodisperse pore-containing bead polymers having a particle size of 10-500 μm.

The present invention relates to a method for the production of monodisperse pore-containing ion exchangers, and also of monodisperse pore-containing bead polymers having a particle size of 10-500 μm.

Pore-containing bead polymers are used as adsorber resins or as impregnation resins in many separation methods, where high-value or poisonous substances are removed in small concentrations from large amounts of liquid. They are also frequently used for chromatographic applications in the analytical and preparative sectors.

In all applications, bead polymers having a particle size as uniform as possible (hereinafter termed “monodisperse”) have significant advantages owing to the more expedient hydrodynamic properties of a bed monodisperse bead polymers. For instance, for example the pressure drop at a given flow rate is significantly less for a bed of monodisperse bead polymers than for the corresponding bed of conventional heterodisperse bead polymers. As a result, reduction of the energy consumption and/or increase of the throughput rate of separation systems is/are possible.

In the chromatography sector, monodisperse bead polymers have the advantage as separation medium of increasing the number of theoretical plates of a chromatography column, minimizing the diffusion front of the substances to be separated and thus enabling sharper and more accurate separation of differing species.

One of the possibilities of producing pore-containing monodisperse bead polymers is in what are termed atomization methods. Atomization methods suitable for ion exchangers are described, for example, in EP-A 0 046 535 and EP-A 0 051 210. A shared characteristic of these atomization methods is their very high technical requirements. The atomization methods generally lead to bead polymers having a particle size of 300-1200 μm. Bead polymers having smaller particle sizes cannot be produced or can be produced only with markedly greater expenditure.

By means of what are termed seed/feed methods, monodisperse bead polymers can likewise be produced. According to this method a monodisperse bead polymer (“seed”) is swollen in the monomer and this is then polymerized. Seed/feed methods are described, for example, in EP-A 0 098 130, EP-A 0 101 943 and EP-A 0 826 704.

EP-A 0 288 006 in turn discloses crosslinked monodisperse bead polymers having a particle size of 1-30 μm. These bead polymers are obtained by a seed-feed method in which crosslinked seed particles are used.

In U.S. Pat. No. 5,231,115, heterodisperse ion exchangers based on crosslinked, pore-containing bead polymers are produced having a particle size of 100-1000 μm. Crosslinked heterodisperse seed particles are used. The crosslinking of the seed particles considerably restricts the increase in mass and volume in the feed step.

EP-A 0 448 391 discloses a method for the production of polymer particles of uniform particle size in the range from 1 to 50 μm. In this method, an emulsion polymer having particle sizes of preferably 0.05 to 0.5 μm is used as seed. To achieve the particle sizes of greater than 10 μm which are of interest for chromatographic applications, numerous feed steps must be repeated with great expenditure.

In WO-A 99/19375, a seed-feed method is described for production of monodisperse expandable polystyrene polymers having a particle size of at least 200 82 m.

In WO-A 01/19885, a single-stage seed-feed method is described for production of porous bead polymers of 10 to 100 μm diameter based on seed particles having a particularly high swellability. The resultant bead polymers are not very suitable for production of ion exchangers.

In U.S. Pat. No. 5,130,343, finally, a seed-feed method is described for production of macroporous bead polymers of uniform particle size of 1 to 20 μm diameter. As porogen, here, use is made of polystyrene which must be extracted after the polymerization by complex methods.

The object of the present invention was to develop a simple method for the production of monodisperse porous ion exchangers of high stability having a particle size of 10-500 μm which were previously inaccessible by known methods.

Subject matter of the present invention and solution of the object is a method for the production of monodisperse pore-containing ion exchangers, characterized in that
a) a noncrosslinked monodisperse seed polymer having a particle size of 0.5 to 20 μm is produced by free-radical initiated polymerization of monoethylenically unsaturated compounds in the presence of a nonaqueous solvent,
b) to an aqueous dispersion of the seed polymer in the presence of a dispersant, at least one monomer feed (A) is added which contains
   0.1 to 5% by weight of initiator and
   95 to 99.9% by weight of monomer
   the monomer feed (A) is allowed to swell into the seed and is polymerized at elevated temperature to give noncrosslinked monodisperse bead polymers,
c) to an aqueous dispersion of the resultant monodisperse bead polymer in the presence of a dispersant, a further monomer feed (B) is added which contains
   0.1 to 3% by weight of initiator,
   5 to 70% by weight of crosslinker,
   15 to 84.9% by weight of monomer and
   10 to 70% by weight of porogen,
   the monomer feed (B) is allowed to swell into the seed and, at elevated temperature, is polymerized to give crosslinked monodisperse pore-containing bead polymers having a particle size of 10 to 500 μm and
d) these crosslinked monodisperse pore-containing bead polymers from method step c) are converted by functionalization into monodisperse pore-containing ion exchangers.

The present invention therefore relates, however, to monodisperse pore-containing ion exchangers, preferably monodisperse pore-containing anion or cation exchangers obtainable by
a) producing a noncrosslinked monodisperse seed polymer having a particle size of 0.5 to 20 μm by free-radically initiated polymerization of monoethylenically unsaturated compounds in the presence of a nonaqueous solvent,
b) adding at least one monomer feed (A) to an aqueous dispersion of the seed polymer in the presence of a dispersant which contains
   0.1 to 5% by weight of initiator and
   95 to 99.9% by weight of monomer,
   swelling the monomer feed (A) into the seed and polymerizing at elevated temperature to give noncrosslinked monodisperse bead polymers,
c) adding a further monomer feed (B) to an aqueous dispersion of the resultant monodisperse bead polymer in the presence of a dispersant which contains
   0.1 to 3% by weight of initiator,
   5 to 70% by weight of crosslinker,
   15 to 84.9% by weight of monomer and
   10 to 70% by weight of porogen,
   allowing the monomer feed (B) to swell into the seed and polymerizing at elevated temperature to give crosslinked monodisperse bead polymers having a particle size of 10 to 500 82 m and
d) functionalizing these crosslinked pore-containing bead polymers from method step c).

Surprisingly, the monodisperse pore-containing ion exchangers produced by the inventive method exhibit improved monodispersity and improved exchange properties compared with the ion exchangers as are known from the abovementioned prior art.

The present invention further relates to a method for producing monodisperse pore-containing bead polymers having a particles size of 10-500 μm, characterized in that
a) a noncrosslinked monodisperse seed polymer having a particle size of 0.5 to 20 μm is produced by free-radical initiated polymerization of monoethylenically unsaturated compounds in the presence of a nonaqueous solvent,
b) to an aqueous dispersion of the seed polymer in the presence of a dispersant, at least one monomer feed (A) is added which contains
   0.1 to 5% by weight of initiator and
   95 to 99.9% by weight of monomer,
   the monomer feed (A) is allowed to swell into the seed and is polymerized at elevated temperature to give noncrosslinked monodisperse bead polymers
c) to an aqueous dispersion of the resultant monodisperse bead polymer in the presence of a dispersant, a further monomer feed (B) is added which contains
   0.1 to 3% by weight of initiator,
   5 to 70% by weight of crosslinker,
   15 to 84.9% by weight of monomer and
   10 to 70% by weight of porogen,
      allowing the monomer feed to swell into the seed and polymerizing it at elevated temperature.

The present invention therefore also relates to monodisperse pore-containing bead polymers having a particle size of 10-500 μm obtainable by
a) producing a noncrosslinked monodisperse seed polymer having a particle size of 0.5 to 20 μm by free-radically initiated polymerization of monoethylenically unsaturated compounds in the presence of a nonaqueous solvent,
b) adding at least one monomer feed (A) to an aqueous dispersion of the seed polymer in the presence of a dispersant which contains
   0.1 to 5% by weight of initiator and
   95 to 99.9% by weight of monomer,
   swelling the monomer feed (A) into the seed and polymerizing at elevated temperature to give noncrosslinked monodisperse bead polymers and
c) adding a further monomer feed (B) to an aqueous dispersion of the resultant monodisperse bead polymer in the presence of a dispersant which contains
   0.1 to 3% by weight of initiator,
   5 to 70% by weight of crosslinker,
   15 to 84.9% by weight of monomer and
   10 to 70% by weight of porogen,
      allowing the monomer feed to swell into the seed and polymerizing at elevated temperature.

For production of the noncrosslinked seed polymer according to method step a), monoethylenically unsaturated compounds are used, no polyethylenically unsaturated compounds or crosslinkers being used.

Suitable compounds are, for example, styrene, vinyltoluene, α-methylstyrene, chlorostyrene, esters of acrylic acid and methacrylic acid such as methyl methacrylate, ethyl methacrylate, methyl acrylate, ethyl acrylate, isopropyl methacrylate, butyl acrylate, butyl methacrylate, hexyl methacrylate, 2-ethylhexyl acrylate, ethylhexyl methacrylate, decyl methacrylate, dodecyl methacrylate, stearyl methacrylate, and isobornyl methacrylate. Preference is given to styrene, methyl acrylate and butyl acrylate. Mixtures of different monoethylenically unsaturated compounds are also highly suitable.

In the production of the noncrosslinked seed polymer according to method step a), the abovementioned monoethylenically unsaturated compound(s) are polymerized in the presence of a nonaqueous solvent with use of an initiator.

Suitable solvents according to the invention are dioxane, acetone, acetonitrile, dimethylformamide and alcohols. Preference is given to alcohols, in particular methanol, ethanol, n-propanol, isopropanol, n-butanol, isobutanol and tert-butanol. Mixtures of various solvents are also very suitable, in particular mixtures of various alcohols. The alcohols can also contain up to 50% by weight of water, preferably up to 25% by weight of water. When solvent mixtures are used, nonpolar solvents, in particular hydrocarbons, such as hexane, heptane and toluene, can be used in conjunction in fractions up to 50% by weight.

The ratio of monoethylenically unsaturated compounds to solvent is 1:2 to 1:30, preferably 1:3 to 1:15.

The production of the seed polymer is preferably performed in the presence of a high-molecular-weight dispersant dissolved in the solvent.

Suitable high-molecular-weight dispersants are natural or synthetic macromolecular compounds. Examples are cellulose derivatives, such as methylcellulose, ethylcellulose, hydroxypropylcellulose, polyvinyl acetate, partially saponified polyvinyl acetate, polyvinylpyrrolidone, copolymers of vinylpyrrolidone and vinyl acetate, and also copolymers of styrene and maleic anhydride. Polyvinylpyrrolidone is preferred. The content of high-molecular-weight dispersant is 0.1 to 20% by weight, preferably 0.2 to 10% by weight, based on the solvent.

In addition to the dispersants, use can also be made of ionic or nonionic surfactants. Suitable surfactants are, e.g., sulfosuccinic acid sodium salt, methyltricaprylammonium chloride or ethoxylated nonylphenols. Preference is given to ethoxylated nonylphenols having 4 to 20 ethylene oxide units. The surfactants can be used in amounts of 0.1 to 2% by weight, based on the solvent.

For the production of the seed polymer according to method step a), suitable initiators are compounds which form free radicals on temperature elevation. Those which may be mentioned by way of example are: peroxy compounds such as dibenzoyl peroxide, dilauryl peroxide, bis(p-chlorobenzoyl) peroxide, dicyclohexyl peroxydicarbonate and tert-amylperoxy-2-ethylhexane, in addition azo compounds such as 2,2′-azobis(isobutyronitrile) or 2,2′-azobis(2-methyliso-butyronitrile). If the solvent contains a water fraction, sodium or potassium peroxydisulfate is also suitable as initiator.

Very suitable compounds are also aliphatic peroxy esters. Examples of these are tert-butyl peroxyacetate, tert-butyl peroxyisobutyrate, tert-butyl peroxypivalate, tert-butyl peroxyoctoate, tert-butyl peroxy-2-ethylhexanoate, tert-butyl peroxyneodecanoate, tert-amyl peroxypivalate, tert-amyl peroxyoctoate, tert-amylperoxy-2-ethylhexanoate, tert-amyl peroxyneodecanoate, 2,5-bis(2-ethylhexanoylperoxy)-2,5-dimethylhexane, 2,5-dipivaloyl-2,5-dimethylhexane, 2,5-bis(2-neo-decanoylperoxy)-2,5-dimethylhexane, di-tert-butyl peroxyazelate or di-tert-amyl peroxyazelate.

The initiators are generally used in amounts of 0.05 to 6.0% by weight, preferably 0.2 to 5.0% by weight, particularly preferably 1 to 4% by weight, based on the sum of the monoethylenically unsaturated compounds.

Inhibitors soluble in the solvent can be used. Examples of suitable inhibitors are phenolic compounds such as hydroquinone, hydroquinone monomethyl ether, resorcinol, catechol, tert-butylcatechol, condensation products of phenols with aldehydes. Further organic inhibitors are nitrogen compounds such as, e.g., diethylhydroxylamine and isopropylhydroxylamine. Resorcinol is preferred as inhibitor. The concentration of the inhibitor is 0.01 to 5% by weight, preferably 0.1 to 2% by weight, based on the sum of the monoethylenically unsaturated compounds.

The polymerization temperature in method step a) is directed by the decomposition temperature of the initiator, and also by the boiling temperature of the solvent, and is typically in the range from 50 to 150° C., preferably 60 to 120° C. It is advantageous to polymerize at the boiling temperature of the solvent, with constant stirring, for example using a gate agitator. Low stirring speeds are used. With 4-liter laboratory reactors, the stirring speed of a gate agitator is 100 to 250 rpm, preferably 100 rpm.

The polymerization time in method step a) is generally a plurality of hours, e.g. 2 to 30 hours.

The seed polymers produced according to the invention in method step a) are highly monodisperse and preferably have particle sizes of 0.5 to 20 μm, particularly preferably 2 to 15 μm. The particle size may be affected, inter alia, by the choice of solvent. For instance, higher alcohols, such as n-propanol, isopropanol, n-butanol, isobutanol and tert-butanol, deliver larger particles than methanol. A fraction of water or hexane in the solvent can shift the particle size towards lower values. By adding toluene, the particle size can be increased.

The seed polymer can be isolated by conventional methods, such as sedimentation, centrifugation or filtration. To separate off the dispersant, the mixture is washed with alcohol and/or water and if desired dried.

In method step b), the seed polymer in aqueous suspension is admixed with a monomer feed (A) of initiator and monomer.

As initiators, the free-radical formers described under method step a) come into consideration. The initiators are generally employed in amounts of 0.1 to 5.0% by weight, preferably 0.5 to 3% by weight, based on the monomer feed (A). Of course, mixtures of the abovementioned free-radical formers can also be used, for example mixtures of initiators having differing decomposition temperature.

Suitable monomers are the monoethylenically unsaturated compounds mentioned in step a). Preference is given to styrene and the esters of acrylic acid and methacrylic acid, in particular methyl acrylate and methyl methacrylate.

The weight ratio of seed polymer to the monomer feed (A) is 1:1 to 1:1000, preferably 1:2 to 1:100, particularly preferably 1:3 to 1:30.

The addition of the monomer feed (A) to the seed polymer in method step b) is generally performed in such a manner that, to an aqueous dispersion of the seed polymer, an aqueous emulsion of the monomer feed is added. Highly suitable emulsions are finely divided emulsions having mean particle sizes of 1 to 10 μm which can be produced using rotor-stator mixers, mixing-jet nozzles or ultrasonic dispersion apparatuses using emulsifying aids, such as, e.g., isooctyl sulfosuccinate sodium salt.

The addition of the monomer feed in method step b) can proceed at temperatures below the decomposition temperature of the initiator, for example at room temperature. It is advantageous to add the emulsion containing the monomer feed with stirring in the course of a relatively long period, e.g. in the course of 0.25 to 5 hours. After addition of the emulsion is completed, it is stirred further, the monomer feed penetrating into the seed particles. A further stirring time of 1 to 15 hours is expedient. The amounts of water used in the production of the seed polymer suspension and monomer feed emulsion are not critical within wide limits. Generally, 5 to 50% strength suspensions or emulsions are used.

The resultant mixture of seed polymer, monomer feed (A) and water is admixed with at least one dispersant, natural and synthetic water-soluble polymers such as, e.g., gelatin, starch, polyvinyl alcohol, polyvinylpyrrolidone, polyacrylic acid, polymethacrylic acid or copolymers of (meth)acrylic acid and (meth)acrylic esters being suitable. Preference is given to cellulose derivatives, in particular cellulose esters and cellulose ethers, such as carboxymethylcellulose, methylcellulose, hydroxyethylcellulose or methylhydroxyethylcellulose. In the context of the present invention it has been found that said cellulose derivatives are particularly highly suitable for preventing particle agglomeration or new formation of particles. In this manner the monodispersity generated in method step a) is completely retained. The amount of dispersants used is generally 0.05 to 1%, preferably 0.1 to 0.5%, based on the water phase.

The water phase in method step b) can, in addition, contain a buffer system which sets the pH of the water phase to a value of between 12 and 3, preferably between 10 and 4. Particularly highly suitable buffer systems contain phosphate, acetate, citrate or borate salts.

It can be advantageous, in method step b), to use an inhibitor dissolved in the aqueous phase. Inhibitors which come into consideration are both inorganic and organic substances. Examples of inorganic inhibitors are nitrogen compounds such as hydroxylamine, hydrazine, sodium nitrite and potassium nitrite. Examples of organic inhibitors are phenolic compounds such as hydroquinone, hydroquinone monomethyl ether, resorcinol, catechol, tert-butylcatechol, condensation products of phenols with aldehydes. Further organic inhibitors are nitrogen compounds such as, e.g., diethylhydroxylamine and isopropylhydroxylamine. Resorcinol is preferred as inhibitor. The concentration of the inhibitor is 5-1000 ppm, preferably 10-500 ppm, particularly preferably 20-250 ppm, based on the aqueous phase.

Elevating the temperature to the decomposition temperature of the initiator, generally 60-130° C., initiates the polymerization of the monomer feed swollen into the seed particles. The polymerization lasts for a plurality of hours, e.g. 3 to 12 hours.

In a further embodiment of the present invention, the monomer feed is added over a relatively long period of 1 to 6 hours at a temperature at which at least one of the initiators used is active. Generally, in this procedure, temperatures of 60-130° C., preferably 60-95° C., are employed.

The resultant noncrosslinked monodisperse bead polymer, before further reaction, to remove dispersants and fine fractions, is washed, for example, with water, drying is generally not necessary.

Method step b), i.e. adding monomer feed, allowing to swell and polymerizing, can be repeated once or a plurality of times, e.g. 1 to 10 times. This means that the product produced in a preceding feed step is used as seed polymer for the subsequent feed step. The multiple repetition of the feed steps ultimately makes monodisperse bead polymers having particle sizes of up to 300 μm accessible from monodisperse seed polymers having particle sizes of 0.5 to 20 μm. The enlargement factor is given here from the polymerization conversion rate and the weight ratio of seed polymer to monomer feed. This is again 1:1 to 1:1000, preferably 1:2 to 1:100, particularly preferably 1:3 to 1:30.

The monodisperse noncrosslinked bead polymer produced in method step b) is, in method step c), in aqueous suspension admixed with a monomer feed (B) of initiator, crosslinker, monomer and porogen.

As initiators, in method step c), in turn, the free-radical formers described in method step a) come into consideration. The initiators are employed in this step generally in amounts of 0.1 to 3.0% by weight, preferably 0.3 to 2% by weight, based on the monomer feed (B).

Crosslinkers are in method step c) compounds having two or more polymerizable olefinically unsaturated double bonds in the molecule. Examples which may be mentioned are divinylbenzene, allyl methacrylate, ethylene glycol dimethacrylate, butanediol dimethacrylate, trimethylolpropane triacrylate, butanediol divinyl ether, diethylene glycol divinyl ether and octadiene. Divinylbenzene, octadiene and diethylene glycol divinyl ether are preferred. The divinylbenzene can be used in commercially available quality which, in addition to the divinylbenzene isomers, also contains ethylvinylbenzenes.

The amount of crosslinker in the monomer feed (B) of method step c) is 5 to 70% by weight, preferably 10 to 60% by weight, in each case based on the monomer feed (B).

Suitable monomers in method step c) are in turn the monoethylenically unsaturated compounds mentioned in method step a). Preference is given to styrene, ethylstyrene, acrylonitrile and the esters of acrylic acid and methacrylic acid, in particular methyl acrylate or methyl methacrylate.

The monomer is used in amounts of 15 to 84.9% by weight, preferably 20 to 65% by weight, based on the monomer feed (B).

As porogens, use is made in method step c) of organic diluents which cause the formation of a pore structure in the bead polymer. Preference is given to such diluents which are less than 10% by weight, preferably less than 1% by weight, soluble in water. Suitable porogens are, e.g., toluene, ethylbenzene, xylene, cyclohexane, octane, isooctane, decane, dodecane, isododecane, methyl isobutyl ketone, ethyl acetate, butyl acetate, dibutyl phthalate.

The porogen is customarily used in amounts of 10 to 70% by weight, preferably 25 to 65% by weight, in each case based on the monomer feed (B).

The weight ratio of noncrosslinked bead polymer from method step b) to the monomer feed (B) is 1:1 to 1:1000, preferably 1:2 to 1:1000, particularly preferably 1:3 to 1:30.

Addition of the monomer feed (B) can proceed in the same manner as has been described for method step b). However, it is also possible, and in many cases advantageous, to share out individual components of the monomer feed (B) and add them separately. It has proved to be particularly expedient in this case to add the component having the better solubility properties first and the component having the poorer solubility properties later. For instance, for example in the case of a monomer feed (B) which consists of dibenzoyl peroxide as initiator, styrene/ethylstyrene as monomer, divinylbenzene as crosslinker and cyclohexane as porogen, an aqueous emulsion of dibenzoyl peroxide, styrene/ethylstyrene and divinylbenzene can be added first and the porogen cyclohexane not until after swelling the mixture, e.g. after 1-8 hours, as further aqueous emulsion. The porogen feed preferably proceeds with stirring in the course of a relatively long period, e.g. in the course of 0.25 to 3 hours. After complete addition of the emulsion, the mixture is stirred further, the porogen feed penetrating into the bead polymer particles. A post-stirring time of 1 to 15 hours is expedient.

Polymerization of the monomer feed (B) swollen into the noncrosslinked bead polymer particles, and also the use of dispersant, buffer system and inhibitor, proceeds in a similar manner to that described in method step b). In method step c), it has also been found that, as dispersant, cellulose derivatives, in particular cellulose esters and cellulose ethers, such as carboxymethylcellulose, methylcellulose, hydroxyethylcellulose or methylhydroxyethylcellulose are particularly highly suitable for preventing particle agglomeration or new formation of particles. In this manner the monodispersity generated in method step b) is completely retained. However, it is also possible to use a dispersant of the abovementioned selection different from method b).

After the polymerization the crosslinked polymer formed can be isolated by customary methods, e.g. by filtration or decantation, and if appropriate after single or repeated washing, dried and if desired sieved.

The particle size of the crosslinked bead polymers produced in method step c) is 10 to 500 μm, preferably 5 to 400 μm, particularly preferably 20 to 300 μm. For determination of the mean particle size and the particle size distribution, customary methods, such as sieving analysis or image analysis, are suitable. As a measure of the width of the particle size distribution of the inventive bead polymers, the ratio of the 90% value (Ø (90) and the 10% value (Ø (10) of the volume distribution is formed. The 90% value (Ø (90) gives the diameter which is greater than 90% of the particles. Correspondingly, the diameter of the 10% value (Ø (10) is greater than 10% of the particles. Monodisperse particle size distributions in the meaning of the invention mean Ø(90)/Ø(10)≦1.5, preferably Ø(90)/Ø(10)≦1.25.

The inventive crosslinked bead polymers obtained in method step c) are pore-containing. Pore-containing, in the context of the present invention, denotes bead polymers which have a specific pore surface area determined by BET nitrogen adsorption between 20 and 2000 m²/g, preferably between 100 and 1800 m²/g, particularly preferably between 200 and 1600 m²/g, and a mean pore size, calculated from the specific pore surface area and the true and apparent density, between 20 and 10 000 Å, preferably between 50 and 5000 Å, particularly preferably between 100 and 2000 Å.

The crosslinked monodisperse pore-containing bead polymers from method step c) can be converted into monodisperse pore-containing ion exchangers by functionalization.

The type of functionalization in method step d) is directed according to the chemical composition of the bead polymers and the desired ion exchanger type.

To generate weakly acidic monodisperse porous cation exchangers, a polymer to be produced according to the invention, having polymerized acrylic ester, methacrylic acid and/or acrylonitrile is hydrolyzed. Suitable hydrolysis agents are strong bases or strong acids such as, e.g., sodium hydroxide solution and sulfuric acid. After hydrolysis, the reaction mixture of hydrolysis product and residual hydrolysis agent is first diluted with water and washed. When sodium hydroxide solution is used as hydrolysis agent, the weakly acidic ion exchanger is present in the Na form. If desired, this cation exchanger can be converted from the sodium form to the acid form. This ion exchange proceeds with sulfuric acid at a concentration of 5-50%, preferably 10-20%.

Anion exchangers can also be produced from bead polymers which are to be produced according to the invention having polymerized acrylic esters, methacrylic acid and/or acrylonitrile. In this case, the bead polymers can be reacted, for example, with an amino alcohol or a bifunctional amine. A preferred amino alcohol is N-N′-dimethyl-2-aminoethanol. A preferred bifunctional amine is N-N′-dimethyl-2-aminopropylamine (“amine Z”).

Crosslinked bead polymers which are to be prepared according to the invention and having polymerized divinylbenzene, styrene and ethylstyrene are preferably used for the production of strongly acidic cation exchangers. The functionalization proceeds by sulfonation. Suitable sulfonating agents are in this case sulfuric acid, sulfur trioxide and chlorosulfonic acid. Preference is given to sulfuric acid of a concentration of 90-100%, particularly preferably 96-99%. The temperature on sulfonation is generally 50-200° C., preferably 90-130° C. If desired, in the sulfonation, a swelling agent, such as, e.g., chlorobenzene, dichloroethane, dichloropropane or methylene chloride, can be employed. After the sulfonation the reaction mixture of sulfonation product and residual acid is cooled to room temperature and diluted first with sulfuric acids of decreasing concentration and then with water. If desired, the cation exchanger obtained according to the invention in the H form can, for purification, be treated with deionized water at temperatures of 70-145° C., preferably 105-130° C. For many applications it is expedient to convert the cation exchanger from its acid form to the sodium form. This ion exchange proceeds using sodium hydroxide solution of a concentration of 10-60%, preferably 40-50%. The temperature during the ion exchange is likewise important. It has been found that with ion exchange temperatures of 60-120° C., preferably 75-100° C., no defects in the ion-exchange beads occur and the purity is particularly expedient.

The crosslinked bead polymers to be produced according to the invention and having polymerized divinylbenzene, styrene and ethylstyrene can also be used for producing anion exchangers. A suitable method in this case is haloalkylation of the bead polymer with subsequent amination. A preferred haloalkylating agent is chloromethyl methyl ether. From the haloalkylated bead polymers, by reaction with a secondary amine, such as dimethylamine, weakly basic anion exchangers can be obtained. Correspondingly, reaction of the haloalkylated bead polymers with tertiary amines such as trimethylamine, dimethylisopropylamine or dimethylaminoethanol, supplies strongly basic anion exchangers.

Anion exchangers can also be produced by what is termed the phthalimide method by amidoalkylation of the bead polymer from method step c), provided that this bead polymer contains polymerized divinylbenzene, styrene and/or ethylstyrene. To produce the amidomethylation reagent, for example a phthalimide or a phthalimide derivative is dissolved in a solvent and admixed with formalin. Subsequently, with elimination of water, a bis(phthalimido) ether is formed therefrom. The bis(phthalimido) ether can if appropriate be converted to the phthalimido ester. Preferred phthalimide derivatives in the context of the present invention are phthalimide itself or substituted phthalimides, for example methylphthalimide. As solvents, in the production of the amidomethylation reagent, use is made of inert solvents which are suitable for swelling the polymer, preferably chlorinated hydrocarbons, particularly preferably dichloroethane or methylene chloride. For functionalization, the crosslinked bead polymer from method step c) is reacted with the amidomethylation reagent. As catalyst, use is made in this case of oleum, sulfuric acid or sulfur trioxide. The reaction temperature is 20 to 120° C., preferably 50 to 100° C. The elimination of the phthalic acid radical and thus the exposure of an aminomethyl group proceed via treatment of the amidomethylated crosslinked bead polymer with aqueous or alcoholic solutions of an alkali metal hydroxide, such as sodium hydroxide or potassium hydroxide, at temperatures between 100 and 250° C., preferably 120-190° C. The concentration of the sodium hydroxide solution is in the range from 10 to 50% by weight, preferably 20 to 40% by weight. The resultant aminomethylated bead polymer is finally washed alkali-free using demineralized water. In a further method step, the aminomethyl-containing bead polymer is converted into ion exchanger by reaction with alkylating agents. Preferably, the alkylation is performed by the Leuckart-Wallach method. A particularly highly suitable Leuckart-Wallach reagent is formaldehyde in combination with formic acid as reducing agent. The alkylation reaction is carried out at temperatures of 20 to 150° C., preferably from 40 to 110° C., and pressures from atmospheric pressure to 6 bar. Subsequently to the alkylation, the resultant weakly basic anion exchanger can be completely or partly quaternized. The quaternization can proceed, for example, via methyl chloride. Further details on the production of anion exchangers by the phthalimide method are described, for example, in EP-A 1 078 688.

From the inventive bead polymers, chelate resins can also easily be produced. For instance the reaction of a haloalkylated bead polymer with iminodiacetic acid produced chelate resins of the iminodiacetic acid type.

The ion exchangers obtained by the inventive method are distinguished by high monodispersity and particularly high stability.

The monodisperse pore-containing anion exchangers produced according to the invention are used
for removing anions from aqueous or organic solutions and their vapors
for removing anions from condensates
for removing color particles from aqueous or organic solutions and their vapors
for decolorizing and desalting glucose solutions, wheys, low-viscosity gelatin broths, fruit juices, fruit musts and sugars, preferably mono- or disaccharides, in particular cane sugar, beet sugar solutions, fructose solutions, for example in the sugar industry, dairies, starch industry and in the pharmaceutical industry,
for removing organic components from aqueous solutions, for example humic acids from surface water,
for separating off and purifying biologically active components such as, for example, antibiotics, enzymes, peptides and nucleic acids from their solutions, for example from reaction mixtures and from fermentation broths,
for analysis of the ion content of aqueous solutions by ion-exchange chromatography.

In addition, the inventive monodisperse pore-containing anion exchangers can be used for the purification and workup of waters in the chemical industry and electronics industry.

In addition, the inventive monodisperse pore-containing anion exchangers can be used in combination with gel-type and/or macroporous cation exchangers for demineralization of aqueous solutions and/or condensates, in particular in the sugar industry.

The monodisperse pore-containing cation exchangers produced according to the invention are also used in different applications. For instance, they are also used, for example in the demineralization of water, in drinking water treatment and in the production of ultrapure water (necessary in microchip production for the computer industry), for the chromatographic separation of glucose and fructose and as catalysts for various chemical reactions (such as, e.g., in the production of bisphenol-A from phenol and acetone).

The present invention therefore relates to the use of the inventive monodisperse pore-containing cation exchangers
for removing cations, color particles or organic components from aqueous or organic solutions and condensates, such as, e.g., process or turbine condensates,
for softening in neutral exchange of aqueous or organic solutions and condensates, such as, e.g., process or turbine condensates,
for purification and workup of waters of the chemical industry, the electronics industry and from power stations,
for demineralization of aqueous solutions and/or condensates, characterized in that these are used in combination with gel-type and/or macroporous anion exchangers,
for decolorizing and desalting wheys, low-viscosity gelatin broths, fruit juices, fruit musts and aqueous solutions of sugars.
for separating off and purifying biologically active components such as, e.g. antibiotics, enzymes, peptides and nucleic acids from their solutions, for example from reaction mixtures and from fermentation broths,
for analysis of the ion content of aqueous solutions by ion-exchange chromatography.

The present invention therefore also relates to
methods for demineralizing aqueous solutions and/or condensates, such as, e.g., process or turbine condensates, characterized in that the inventive monodisperse pore-containing cation exchangers are used in combination with heterodisperse or monodisperse, gel-type and/or macroporous anion exchangers,
combinations of monodisperse pore-containing cation exchangers produced according to the invention with heterodisperse or monodisperse, gel-type and/or macroporous anion exchangers for demineralizing aqueous solutions and/or condensates, such as, e.g., process or turbine condensates,
methods for purification and workup of waters of the chemical industry, the electronics industry and from power stations, characterized in that the inventive monodisperse pore-containing cation exchangers are used,
methods for removing cations, color particles or organic components from aqueous or organic solutions and condensates, such as, e.g., process or turbine condensates, characterized in that the inventive monodisperse pore-containing cation exchangers are used,
methods for softening in neutral exchange of aqueous or organic solutions and condensates, such as, e.g., process or turbine condensates, characterized in that the inventive monodisperse pore-containing cation exchangers are used,
methods for decolorizing and desalting wheys, low-viscosity gelatin broths, fruit juices, fruit musts and aqueous solutions of sugars in the sugar industry, starch industry or pharmaceutical industry or dairies, characterized in that the monodisperse pore-containing cation exchangers produced according to the invention are used,
methods for separating off and purifying biologically active components such as, e.g., antibiotics, enzymes, peptides and nucleic acids from their solutions, for example from reaction mixtures and from fermentation broths, characterized in that the inventive monodisperse pore-containing cation exchangers are used,
methods for analysis of the ion content of aqueous solutions by ion-exchange chromatography, characterized in that the inventive monodisperse pore-containing cation exchangers are used.

The monodisperse pore-containing bead polymers produced according to the invention according to method step c) can also be used in a multitude of applications, such as, e.g., for separating off and purifying biologically active components from their solutions, for analysis of the ion content of aqueous solutions by ion-exchange chromatography, for removing color particles or organic components from aqueous or organic solutions and as support for organic molecules such as chelating agents, enzymes and antibodies.

The present invention therefore also relates to the use of the inventive monodisperse pore-containing bead polymers
for separating off and purifying biologically active components such as, for example, antibiotics, enzymes, peptides and nucleic acids from their solutions, for example from reaction mixtures and from fermentation broths,
for removing color particles or organic components from aqueous or organic solutions,
as support for organic molecules such as chelating agents, enzymes and antibodies, which are either adsorbed to the support or are covalently or ionically fixed by reaction with a functional group present on the support.

The present invention therefore also relates to
methods for separating off and purifying biologically active components such as, e.g., antibiotics, enzymes, peptides and nucleic acids from their solutions, for example from reaction mixtures and fermentation broths, characterized in that use is made of the inventive monodisperse pore-containing bead polymers,
methods for removing color particles or organic components from aqueous or organic solutions, characterized in that use is made of the inventive monodisperse pore-containing bead polymers,
methods for binding organic molecules such as chelating agents, enzymes and antibodies to a support, characterized in that use is made of the inventive monodisperse pore-containing bead polymers as support.

### EXAMPLES

### Example 1

1a) Production of Seed Polymer 1a

2400 g of n-butanol and 180 g of polyvinylpyrrolidone (Luviskol® K30) were stirred for 60 min in a 4 liter three-necked flask, a homogeneous solution being obtained. The reactor was then flushed with a nitrogen stream of 20 l/h and 300 g of styrene were added in the course of a few minutes with further stirring at 150 rpm. The reactor was heated to 80° C. When a temperature of 71° C. was reached, a solution of 3 g of azodiisobutyronitrile and 117 g of n-butanol heated to 40° C. was added all at once. The stirring speed was increased to 300 rpm for 2 min. After return to 150 rpm, the nitrogen stream was shut off. The reaction mixture was kept at80° C. for 20 h. Thereafter, the reaction mixture was cooled to room temperature, the resultant polymer was isolated by centrifugation, washed twice with methanol and twice with water. This produced in this manner 2970 g of an aqueous dispersion of seed polymer 1a having a solids content of 10% by weight. The particle size was 2.9 μm, Ø(90)/Ø(10) was 1.29.

1b-1) Production of Seed Polymer 1b-1

In a plastic vessel, a finely divided emulsion-I was produced from 300 g of styrene, 9.24 g of 75% strength by weight dibenzoyl peroxide, 500 g of water, 3.62 of ethoxylated nonylphenol (Arkopal® N060), 0.52 g of isooctyl sulfosuccinate sodium salt and 2 g of 3,3′,3″,5,5′5″-hexa-tert-butyl-alpha, alpha′, alpha″-(mesitylene-2,4,6-triyl)tri-p-cresol (Irganox® 1330 inhibitor) using an Ultraturrax (3 min at 13 500 rpm).

A solution of 10 g of methylhydroxyethylcellulose in 2245 g of deionized water, 400 g of aqueous dispersion from 1a) (40 g of solid) and 500 g of water was charged into a 4 l three-necked flask which was flushed with a nitrogen stream of 20 l/h. At room temperature, with stirring, the finely divided emulsion-I was pumped in at constant rate in the course of 3 hours. The batch was left to stand for a further 13 hours at room temperature and then heated to 80° C. for 9 hours. Thereafter, the reaction mixture was cooled to room temperature, the resultant polymer isolated by centrifugation, washed twice with methanol and twice with water and dispersed in water. This produced in this manner 1438 g of an aqueous dispersion having a solids content of 18.95% by weight. The particle size was 6.6 μm, the Ø(90)/Ø(10) value was 1.33.

1b-2) Production of Seed Polymer 1b-2

Step 1a) was repeated, but together with the solution of 10 g of methylhydroxyethylcellulose in 2245 of deionized water, 211 g of the dispersion from 1b-1) (40 g of solid) and 700 g of water were charged.

The resultant polymer was isolated by centrifugation, washed twice with methanol and twice with water and dispersed in water. This produced in this manner 1403 g of an aqueous dispersion having a solids content of 13.3% by weight. The particle size was 13.1 μm, the Ø(90)/Ø(10) value was 1.33.

1c) Production of Pore-Containing Bead Polymer 1

In a plastic vessel, a finely divided emulsion-II was produced from 101.7 g of technical grade divinylbenzene (approximately 80% by weight divinylbenzene content), 22.9 g of styrene, 203.4 g of toluene, 2 g of dibenzoyl peroxide, 515 g of water, 4.6 g of ethoxylated nonylphenol (Arkopal® N060), 0.80 g of isooctyl sulfosuccinate sodium salt and 2 g of 3,3′,3″5,5′5″-hexa-tert-butyl-alpha,alpha′,alpha″-(mesitylene-2,4,6-triyl)tri-p-cresol (Irganox 1330 inhibitor) using an Ultraturrax (3 min. at 10 000 rpm).

A solution of 10 of methylhydroxyethylcellulose in 2245 of deionized water, 100 g of aqueous dispersion from 1b-2) and 410 g of deionized water was charged into a 4 l three-necked flask which was flushed by a nitrogen stream of 20 l/h. At room temperature, with stirring, the finely divided emulsion-II was pumped in at constant rate in the course of 3 hours. The batch was left to stand at room temperature for a further 13 hours and then heated to 80° C. for 12 hours. Thereafter the reaction mixture was cooled to room temperature, the resultant polymer decanted off twice in methanol and subsequently copiously washed with water on a vacuum filter. After drying for 24 in the vacuum drying cabinet, this produced 89 g of finely divided porous beads having apparent density 0.29 g/cm³. The yield was 65%, the particle size was 28 μm, the Ø(90)/Ø(10) value was 1.31. The bead polymers had a BET pore surface area of 37.8 m²/g and a mean pore diameter of 100 nm.

### Example 2

2c) Production of Pore-Containing Bead Polymer 2

The procedure was followed as in 1c), but for production of emulsion-II, 203.4 g of cyclohexane were used instead of toluene.

This produced 68 g of finely divided porous beads. The yield was 50%, the particle size was 28 μm, the Ø(90)/Ø(10) value was 1.28. The bead polymers had a BET surface area of 54 m²/g and a mean pore diameter of 79 nm.

2d) Production of Strongly Acidic Cation Exchanger 2

39.7 g of the pore-containing bead polymer from 2c) and 414 g 98% strength sulfuric acid were charged into a 1 liter 4-necked flask equipped with intensive cooler and agitator. The agitator was switched on (agitator speed 150 rpm), the mixture was heated 115° C. and held at 115° C. with stirring for 8 hours. Subsequently, the reactor contents were cooled to room temperature and, on a vacuum filter, successively washed with 500 ml in each case of 78% strength, 50% strength and 20% strength sulfuric acid. Subsequently the product was washed with demineralized water until the pH of the effluent was virtually neutral (pH 6 to 8).

This produced approximately 150 g of brown pore-containing cation exchanger beads having a mean diameter of 33 μm and a solids content of 30.5% by weight. The number of whole, round, undamaged beads was more than 90% of the total number of particles. The content of strongly acidic groups was 1.28 mmol per milliliter of moist resin in the H form.

### Example 3

3a) Production of Seed Polymer 3a

A polystyrene seed polymer was produced as in 1a).

This produced 2985 g of an aqueous dispersion of seed polymer 3a having a solids content of 9.1% by weight. The particle size was 3.8 μm.

3b-1) Production of Seed Polymer 3b-1

The procedure was followed as in 1b-1) based on seed polymer 3a. This produced 1565 g of an aqueous dispersion of seed polymer 3b-1 having a solids content of 16.1% by weight. The particle size was 7.4 μm, the yield was 75%.

3b-2) Production of Seed Polymer 3b-2

The procedure was followed as in 1b-2) based on seed polymer 3b-1. This produced 1062 g of an aqueous dispersion of seed polymer 3b-2 having a solids content of 15.3% by weight. The particle size was 15 μm, the yield was 48%.

3b-3) Production of Seed Polymer 3b-3

The procedure was followed as in 1b-2) based on seed polymer 3b-2. This produced 1050 of an aqueous dispersion of seed polymer 3b-3 having a solids content of 31.1% by weight. The particle size was 25 μm.

3c) Production of Seed Polymer 3

The procedure was followed as in 1c) based on seed polymer 3b-3. This produced 46 g of finely divided porous beads. The particle size was 59 μm, the Ø(90)/Ø(10) value was 1.21.

1-8. (canceled)

9. A method of producing a monodisperse pore-containing ion exchanger, comprising:
a) producing a noncrosslinked monodisperse seed polymer having a particle size of 0.5 to 20 μm by free-radical initiated polymerization of a monoethylenically unsaturated compound in the presence of a nonaqueous solvent;
b) adding to an aqueous dispersion of the noncrosslinked monodisperse seed polymer at least one monomer feed (A), said monomer feed (A) comprising
0.1 to 5% by weight of initiator and
95 to 99.9% by weight of monomer,
wherein the monomer feed (A) is allowed to swell into the seed and is polymerized at an elevated temperature, whereby a noncrosslinked monodisperse bead polymer results;
c) adding to an aqueous dispersion of the noncrosslinked monodisperse bead polymer at least one further monomer feed (B), said further monomer feed (B) comprising
0.1 to 3% by weight of initiator,
5 to 70% by weight of crosslinker,
15 to 84.9% by weight of monomer and
10 to 70% by weight of porogen,
wherein the monomer feed (B) is allowed to swell into the seed and is polymerized at an elevated temperature, whereby a crosslinked monodisperse pore-containing bead polymer results, said crosslinked monodisperse pore-containing bead polymer having a particle size of 10 to 500 μm; and
d) functionalizing the crosslinked monodisperse pore-containing bead polymer thereby forming the monodisperse pore-containing ion exchanger.

10. The method according to claim 9, wherein the adding step c) is performed in the presence of a dispersant.

11. The method according to claim 10, wherein the dispersant comprises at least one water-soluble cellulose derivative.

12. A monodisperse pore-containing ion exchanger produced according to the method of claim 9.

13. The monodisperse pore-containing ion exchanger according to claim 12, wherein said functionalizing step d) is carried out so that the monodisperse pore-containing ion exchanger is an anion exchanger.

14. The monodisperse pore-containing ion exchanger according to claim 12, wherein said functionalizing stop d) is carried out so that the monodisperse pore-containing ion exchanger is a cation exchanger.

15. A method of producing a monodisperse pore-containing bead polymer comprising:
a) producing a noncrosslinked monodisperse seed polymer having a particle size of 0.5 to 20 μm by free-radical initiated polymerization of a monoethylenically unsaturated compound in the presence of a nonaqueous solvent;
b) adding to an aqueous dispersion of the noncrosslinked monodisperse seed polymer at least one monomer feed (A), said monomer feed (A) comprising
0.1 to 5% by weight of initiator and
95 to 99.9% by weight of monomer
wherein the monomer feed is allowed to swell into the seed and is polymerized at an elevated temperature, whereby a noncrosslinked monodisperse bead polymer results;
c) adding to an aqueous dispersion of the noncrosslinked monodisperse bead polymer a further monomer feed (B) comprising
0.1 to 3% by weight of initiator,
5 to 70% by weight of crosslinker,
15 to 84.9% by weight of monomer and
10 to 70% by weight of porogen,
wherein the monomer feed (B) is allowed to swell into the seed and is polymerized at elevated temperature, thereby forming the monodisperse pore-containing bead polymer, said monodisperse pore-containing bead polymer having a particle size of 10 to 500 μm.

16. The method according to claim 15, wherein the adding step c) is performed in the presence of a dispersant.

17. The method according to claim 16, wherein the dispersant comprises at least one water-soluble cellulose derivative.

18. A monodisperse pore-containing bead polymer produced according to the method of claim 15.

19. A process for removing a anion from a substance or mixture, said substance or mixture being in liquid, solid, or gaseous form, comprising:
contacting the monodisperse pore-containing anion exchanger according to claim 15 with the substance or mixture.

20. A process for removing a cation from a substance or mixture, said substance or mixture being in liquid, solid, or gaseous form, comprising:
contacting the monodisperse pore-containing cation exchanger according to claim 15 with the substance or mixture.
